(19) United States
(12) Patent Application Publication
(10) Pub. No.: US 2004/0164570 A1
(43) Pub. Date: Aug. 26, 2004

(54) Garden tool device

(76) Inventor: Thomas Souza JR., Honolulu, HI (US)

Correspondence Address: Fleshner & Kim, LLP, P. O. Box 221200, Chantilly, VA, 20153-1200, US

(21) Appl. No.: 10/421,817

(22) Filed: Apr. 24, 2003

Related U.S. Application Data
(60) Provisional application No. 60/448,481, filed on Feb. 21, 2003.

(51) Int. Cl. A01B 1/00

(52) U.S. Cl. 294/51

(57) ABSTRACT

A digger and utility garden tool including a specially shaped head. The specially shaped head can include a head with a serrated blade surface with spaces between protrusions on one edge of the serrated blade surface and/or a “U” shape portion which includes a space in a central portion thereof.

### BACKGROUND OF THE INVENTION

This application claims priority to the Provisional Application Serial No. 60/448,481 filed on Feb. 21, 2003.

1. Field of the Invention

The present invention relates to a digger and utility garden tool for non-mechanized digging and gardening.

2. Background of the Related Art

In the past, picks and other handle-based tools have been used to tool the ground and prepare areas for agricultural use. However, picks, hoes, shovels, rakes, tampers, axes and the like, for example, tend to be heavy and unwieldy and can often be difficult to use without great strength. As such, a tool that is easier to use is needed.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the invention is to provide a corrugated polymer headed tool, including a corrugated polymer head including a planar polymer sheet which includes at least one side surface with protrusions and spaces between the protrusions, with the protrusions and the spaces coplanar with the planar polymer sheet.

Another object of the invention is to provide a tool, including a head which includes a planar bottom portion, two triangular shaped side portions and a front portion, with the front portion including a shaped planar sheet, with the planar sheet is shaped into a “U” shape which includes a space in a central portion thereof, and with the two triangular shaped side portions protruding in the front portion to create a pair of protrusions on upper portions of the front portion.

Another object of the invention is to provide a digger and utility garden tool, including a head including a first side which includes a planar bottom portion, two triangular shaped side portions and a front portion, with the front portion including a shaped planar sheet, with the planar sheet is shaped into a “U” shape which includes a space in a central portion thereof, and with the two triangular shaped side portions protruding in the front portion to create a pair of protrusions on upper portions of the front portion, and a second side which includes a serrated blade surface with spaces between protrusions on one edge of the serrated blade surface on the other side, with the “V” shape rectangular or conical, with the spaces in the serrated blade surface circular, semicircular, v-shaped, or rectangular, with the head and the serrated blade surface concave, with the head and the serrated blade surface including ridges that increase the strength and stiffness of the tool, with the head including a polymer, metal or a metal alloy, and further includes a flange that reinforces side portions of the tool, and with the head further including a single 60 degree bevel on a bottom edge of the head, and a handle, with the handle including a fixed shaft with a ball mounted onto one end, a bent shaft, a double rod handle or a dagger type handle.

Another object of the invention is to provide a tool, including a head including a serrated blade surface with spaces between protrusions on one edge of the serrated blade surface.

Another object of the invention is to provide a tool, including a head including a serrated blade surface with spaces between protrusions on one edge of the serrated blade surface, with the spaces adaptively sized for a predetermined, specific use.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIGS. 1 to 51 illustrate preferred embodiments of the present invention.

### DETAILED DESCRIPTION OF PREFERRED EMBODIMENTS

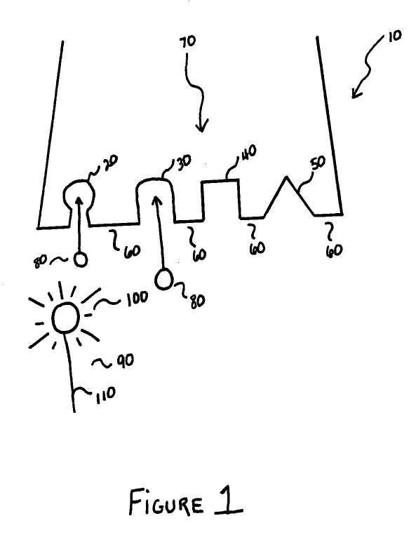

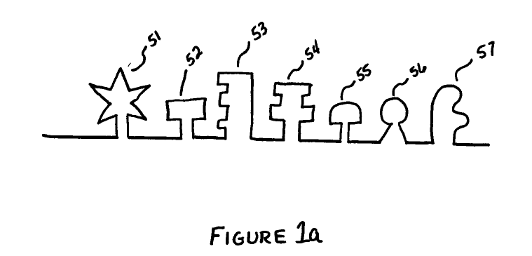

As illustrated in FIGS. 1 and 5, a first preferred embodiment of the present invention includes a handle and a specially designed head for penetrating dirt, gravel or the like. The specially designed head 10, as illustrated in FIG. 1, preferably includes a modified serrated blade surface 70 that focuses force from the handle onto protruding sections 60 of the blade surface 70 thus yielding a higher force per unit area. This increased force can allow less total force to be supplied by a user while a higher concentrated force is applied to the subject surface at the protruding sections 70. Thus, less thrust is required for a given job.

The modified serrated blade surface 70, as illustrated in FIG. 1, can include protrusions 60 with spaces 20, 30, 40, 50 in between each protrusion to allow more dirt or the like to be moved with less effort and energy from the user. This is because it does not have a uniform blade surface as the blade 70 allows the head 10 to pass more easily through masses of dirt or the like.

The spaces in the head, as illustrated in FIGS. 1 and 1a, can be circular shaped 20, semicircular, teardrop or u-shaped 30, rectangular-shaped 40, v-shaped 50, star-shaped 51, or with any other shaped space, such as any regular 52, 54, 55 or 56 or irregular shape 53, 57 as needed. Using a polymer would advantageously allow for many different shapes of spaces to be employed, as a polymer could be easily molded or shaped as needed. Additionally, the spaces can also be interchanged and mixed as needed.

The shape of the space is preferably chosen based upon the material that must pass though each space and the ease of manufacture. For example, when the tool is used to dig and loosen dirt, loose portions of the dirt 80 will be able to pass through the spaces 20, 30, 40, 50 between the protrusions 60.

As mentioned above, preference between these shapes can be determined based upon the usage and the ease of manufacture. For example, circular shaped spaces 20 may be preferable for moving small, round pebbles or dirt 80 or to remove small surface weeds 90. As another example, a semicircular shaped space 30 can be used to maximize the material being passed through the space including a rounded end which can pass rounded material at a certain depth.

As another example, rectangular shaped spaces 40 can be used to simplify manufacture and allow passage of a variety of shaped debris. As yet another example, triangular shaped spaces 50 may be employed to allow more material to pass through at shallower depths than at deeper depths.

As yet another example, star shaped spaces 51 maybe employed to allow material smaller than the center of the star to pass through with spaces surrounding the center for easier movement. As another example, a rectangular slotted shape 52 maybe employed to allow larger material pieces, which are smaller than the rectangular upper section to pass only at a certain depth.

Another preferred space shape is a single sided grooved space 53, which can allow for more material to be moved from one side of the space than from the other. As yet another example, multiple grooved spaces 54 may be employed to allow pass large amounts of material in a single pass, while catching material of any size greater than any of the dimensions of the space. As another example, a semicircular slotted space 55 may be employed to separate larger debris from smaller debris at a certain depth from a digging surface.

Another preferred space shape may also be a key hole shaped space 56 which can allow for pebbles to be caught in the circular area, while passing other debris through a slotted section. Another preferred space shape may also be an irregular shape 57, which can be adapted for any use. For example, the space may include all rounded edges in order to prevent breakage during use.

The spaces 20, 30, 40, 50, 51-57 between the protrusions 60 and the protrusions 60 themselves can also be wider or narrower depending on the desired application. For example, in lightly packed dirt, the protrusions can be narrower with narrower spaces in order to move a higher mass of dirt per use. Alternately, in heavily packed dirt, wider protrusions and wider spaces may be desired to prevent breakage and to decrease the total surface area of the modified serrated blade 70.

Preferably, the head further includes ridges or corrugations (hereinafter collectively referred to as “ridges”) along a non-impact surface in order to strengthen the head. As illustrated in FIG. 5, the ridges 120 can be formed in a direction approximately perpendicular to the modified serrated surface 70 in order to strengthen the head 10 against possible crushing when force is applied to the modified serrated surface 70. The ridges 120 are preferably formed between the spaces 20 including the protrusions 60 in the modified serrated surface 70 and are formed over an area from the modified serrated surface 70 toward a handle insertion point 130 in order to increase the strength and stiffness of the head 10. By offsetting each portion of the blade 70 between the spaces 20, the creased portions of each ridge 120 can increase the strength and stiffness of the entire head 10.

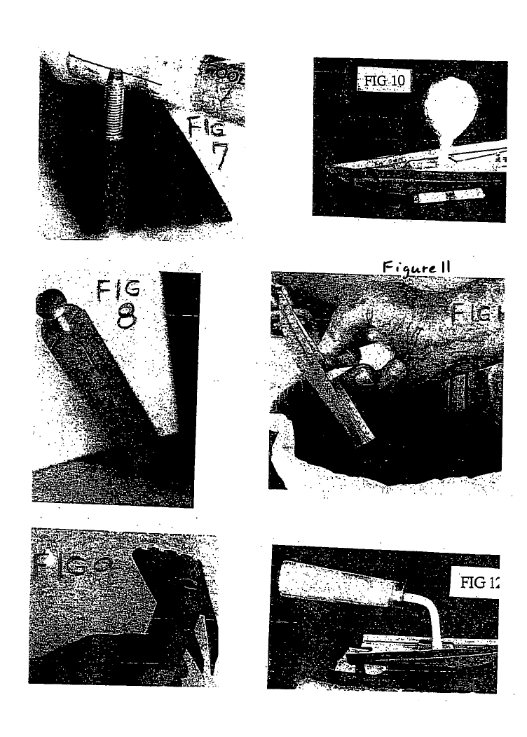

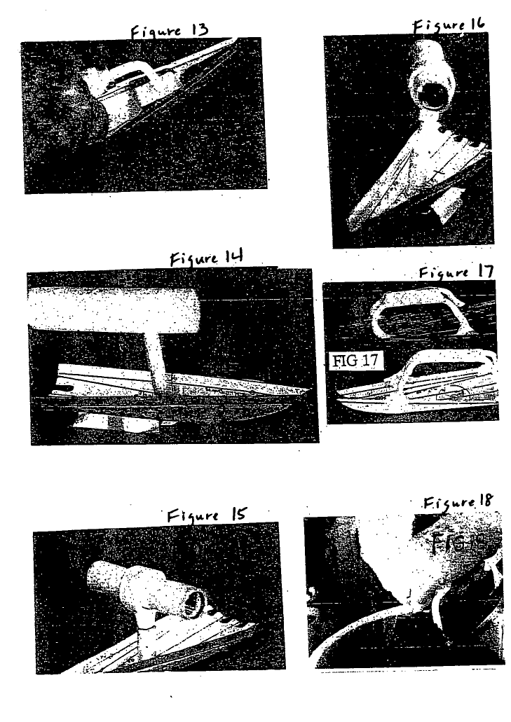

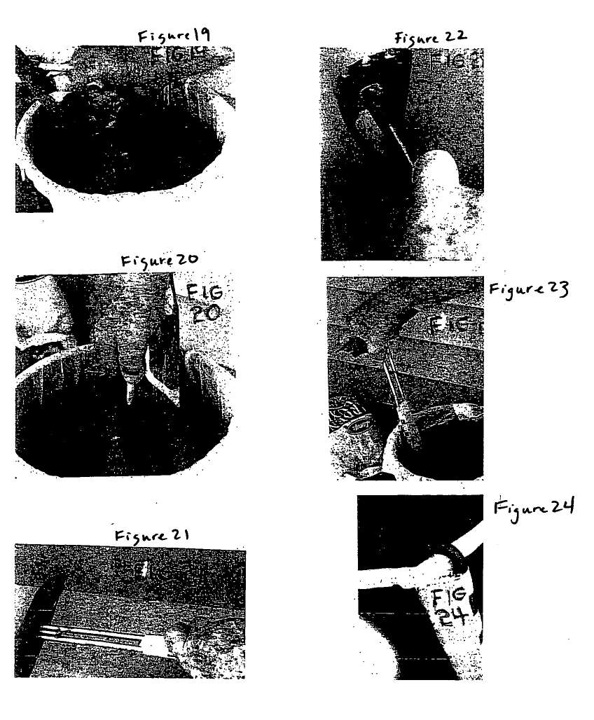

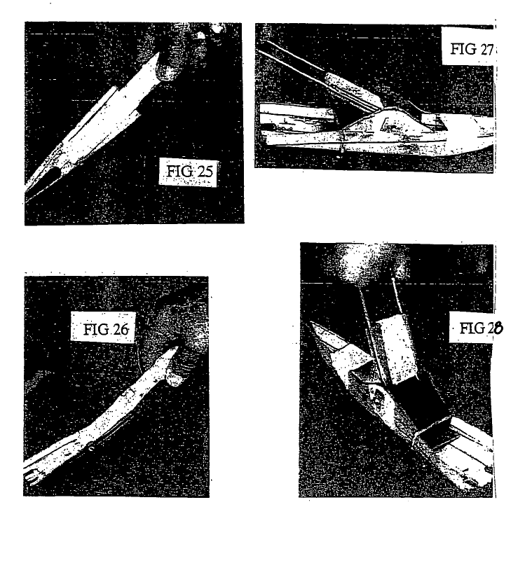

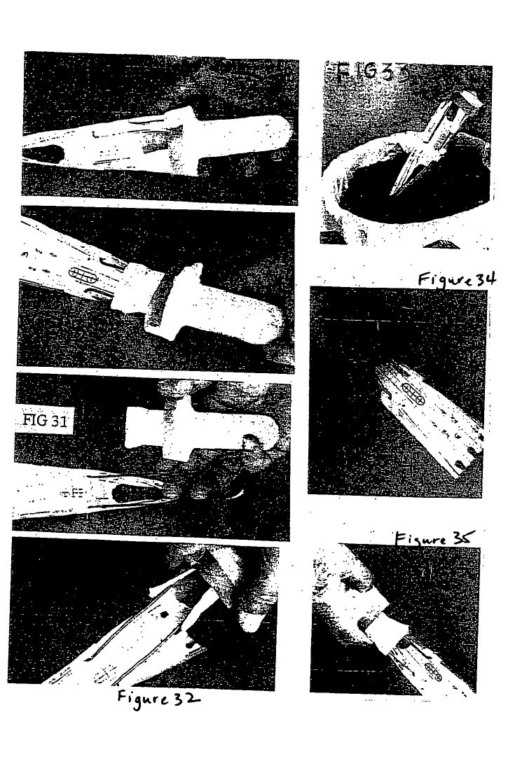

The ridges 120 can also be of any shape including triangular, rectangular, rounded or the like. The shape of the ridges can be determined by the end use or manufacturing requirements, as needed. Additionally, the ridges can protrude from a plane or can be used to shape the curvature of the head. By this, as illustrated in FIG. 5, the head can be essentially planar with ridges within the plane, or as illustrated in FIG. 3, the head can be rounded with the ridges forming the changes in plane for the head.

The modified serrated blade surface is preferably concave in shape, although it may be made to be flat or rectangular as needed. The concave shape allows the tool to include a minimal edge surface that can be more easily be used to cut through surfaces. Additionally, with the serrated blade surface, the tool can be used as a saw to cut items as needed.

The serrated blade surface can be used not only for digging, but also for cutting, clearing, grabbing and carrying through the use of the serrations. Items like brush, weeds, or other debris can be entwined between the serrations for carrying, removal, or any other later treatment. Also, in conjunction with the preferred concave shape, the tool can be used for moving items, such as dirt or other debris, in an efficient manner.

The tool including a serrated blade surface may also include a flange to reinforce side portions of the tool. This flange can provide additional strength to the overall tool, as well as adding a cutting edge for the blade and increase the stiffness of the tool or minimize vibration transfer, as needed

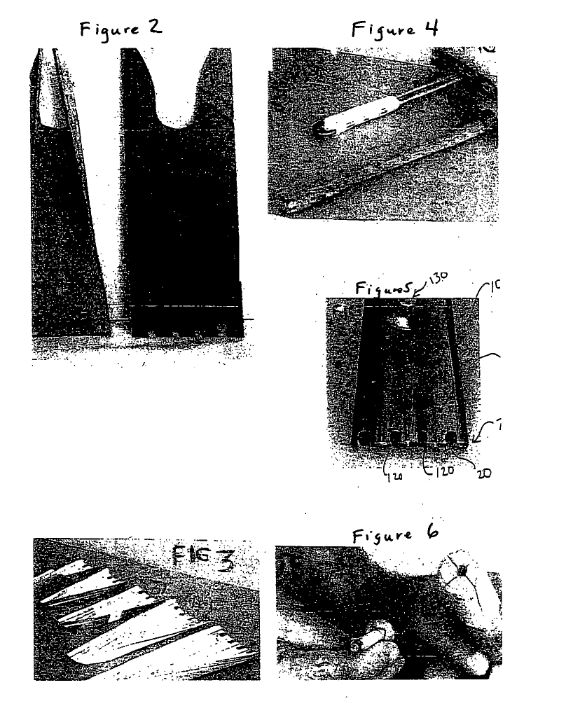

In a second preferred embodiment of the present invention, as illustrated in FIG. 2, another design for a head can be used. In this preferred embodiment, a head which includes a planar bottom portion, two triangular shaped side portions and a front portion. Even more preferably, the front portion includes a shaped planar sheet with the planar sheet shaped into a “U” shape which includes a space in a central portion thereof, and where the two triangular shaped side portions in the front portion to create a pair of protrusions or “tines” which are formed to protrude from the front portion of the head.

The shape and design of this head allows maximum force for minimal area and weight, thus concentrating the thrust force in one place with a less bulky, lighter tool. Thus, digging and breaking up hard surfaces is easier and requires less strength. The shape and design of the head allows dirt or the like to pass through the space in the central portion, but still provides force applied through the tines for breaking up hardened ground or other surfaces. Additionally, the head can be used not only for digging, but also for extracting and removing plants, weeds or other items that may be embedded in the ground or other surface.

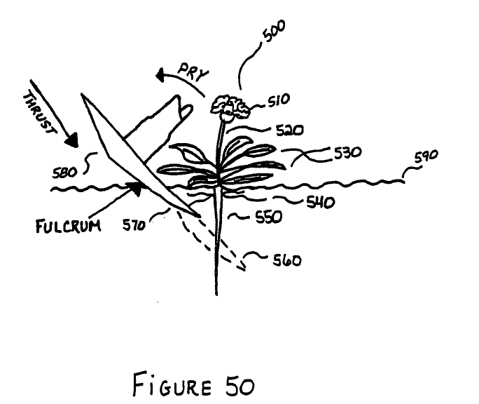

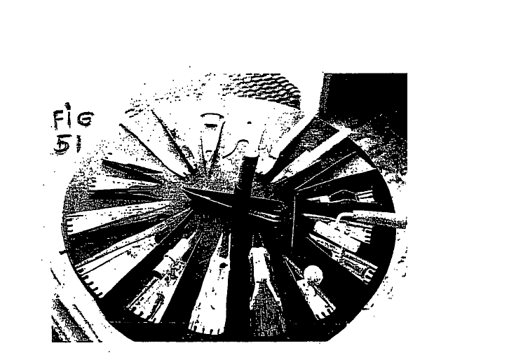

The head can also be utilized for grabbing and carrying items through the use of the space in the central portion, which essentially can use the tines as a type of “fork lift” or to catch items between the tines like a wedge. As illustrated in FIG. 50, items, such as dandelion, can be surrounded at the root by the tines and then the dandelion bonnet can be lodged and held in the space at the as the head for easy removal. This allows for the entire dandelion, including the tap root, to be removed without shearing of the plant or the weed. The shaped opening allows for items of various sizes to be wedged at varying positions of the head.

The ratio of the taper of the “U” shape can be manipulated in order to specialize the shape of the head for specific uses, where the “U” shape can be extremely sharp and include a small, acute angle between the sides, can be intermediate with a moderate angle between the sides, or can be obtuse with a large, obtuse angle between the sides. Of course, the sharper the “U” shape, the higher amount of force per unit area and thus potentially a deeper, narrower penetration, but the lower amount of total area per use and thus potentially a shallower, wider penetration.

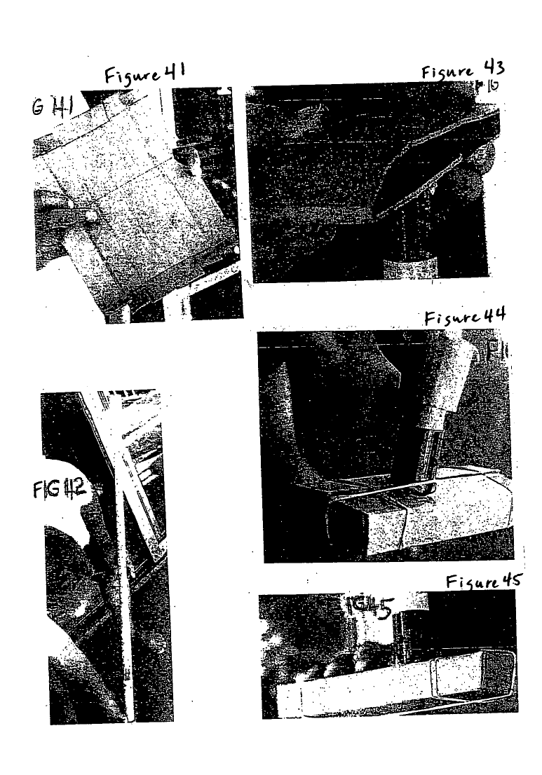

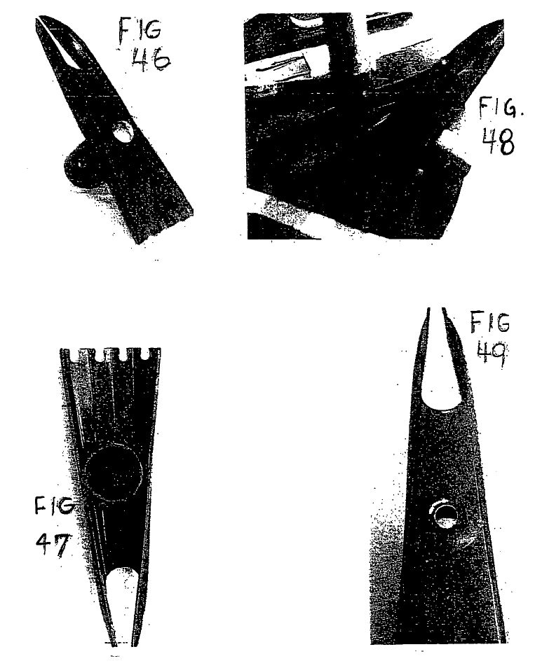

Additionally, the “U” shape can be short and spaced apart, as illustrated in FIGS. 36-40 in order to provide a tool for digging up vegetation such as weeds or dandelions, as mentioned above. The “U” shape can also have long protruding sides in order to provide for deeper penetration as needed.

Additionally, the “U” shape can also be vertically rectangular or conical in shape, as illustrated in FIGS. 36 and 3, respectively. While a rectangular shape may decrease the costs of manufacture and may also be desirable for structural reasons, a conical shape can be used to control any feedback vibration that may be transferred to the user. Thus, in order to control the thrust vibration and thus also presumably reduce user fatigue, a conical shape is preferable.

The shape of the tool is also important to allow for removal from the ground after use. The “exit hole” is preferably at least as large, if not larger, than the “entry hole” in order to allow dirt, mud or the like to easily slide off or be removed from the tool.

The shape of the tool is also important to achieve specific goals. For example, the “U” shaped side preferably is shaped as illustrated in FIGS. 47 and 49 to enable extraction of a plant including its root. As illustrated in FIG. 50, the tines 570 of the tool 580 are important to break the soil to a depth below the surface of the ground 590 and to loosen the soil around the root 550. The tines preferably extend be below a leaf bonnet area 530, but on either side of the root 550 so that the soil around the root will release the root for extraction. The tool allows for a top side of the tool rest on the ground and create a fulcrum point for applying force. Thus, the entire plant including the root can be extracted by using the leaf bonnet area caught between the tines as the gripping point and the top of the tool as a fulcrum while not severing the root, which was released by the tines extended below the surface of the ground.

Additionally, the tines can be used to dig around other plants or items in ground surfaces or the like. The space between the tines can be adaptively sized and shaped for different purposes, such as for allowing the tines to have a greater spacing than trees, specific garden plants, etc.

The first and second preferred embodiments can be made in conjunction with one another on a single head, as illustrated in FIG. 3. Thus, the “U” shaped side can be used to breaking up hard ground or the like using, while the other side can be the modified serrated blade used to move the broken up ground, dirt or the like.

Additionally, tools according to the present invention can be made of any strong, lightweight material. Preferably, a light metal, polymer or similar light, but strong material is used to preserve the strength and ease of use of the tool. The material is important to provide a stable material that is easy to shape into a tool head.

A polymer may be preferable, as polymers may be high strength, lightweight and low cost. Additionally, a polymer may also be more desirable depending upon the final shape of the head, as using a polymer can enables the head to be more easily manufactured into a variety of shapes as polymers can often be easily molded. Also, using a polymer may allow for the head and the specific shapes involved in the head to be more easily adapted to any specific use.

The polymer can be any thermoset polymer or thermoplastic polymer. Preferably, the polymer is an engineering polymer with sufficiently high strength and stiffness to permit substitution for traditional structural metals, such as polyurethane or nylon.

The material used, however, may preferably be a metal. While any metal can be used, preferably a lightweight, a high strength, non-brittle material is used. A lightweight metal is preferred for its fracture toughness which allows for deformation, rather than breakage, of the tool if the loading exceeds the material strength. This is desirable in order to increase the safety of using this tool. The high fracture toughness would allow for a tool using a lightweight metal head to be used beyond the deformation strength of the material with deformation and without fracture or breakage. This would be advantageous in that it may allow the tool to be used under higher forces and also may prevent injury that may be caused by sudden failure or breakage of the tool. While any metal can be used, metals with higher strength and lighter weight are preferred, such as aluminum alloys and lightweight, low-alloy steels.

Additionally, if the tool is made of a metal, the shaping can be done by cold working or any other method known by one skilled in the art. Cold working is a preferable manner of shaping as the strength to weight ratio can be improved through this method of manufacture.

In order to manufacture a tool of the present invention, preferably a monolithic blank, as illustrated in FIG. 2, is provided. The blank can then be shaped into the tool as needed. However, the tool can also be manufactured by molding, tooling or other methods known by one in the related field.

Preferably, a tool according to the present invention can be made in different sizes, as illustrated in FIG. 3, for different users and different applications. Depending on the size and strength of the user, as well as the conditions in which the user will use the tool, a bigger or smaller tool may be desired. Additionally, the handle can also be adjusted with respect to the user and the tool head. Preferably, the handle is a rod that can be made of any material. For instance, non-limiting examples include wood, polymer, metal or the like. Preferably, the handle is made of ash wood for the grain, weight, longevity and structural characteristics, as well as the amount of vibration it can absorb. Alternately, hickory wood can be used, but can increase both the weight and the cost of the final tool. Additionally, a polymer can be used, preferably a thermoset polymer such as polyurethane.

The handle can be made in several ways and can be made to be fixed or interchangeable with a variety of tools. Preferably, the handle is uniformly split into four sections, as illustrated in FIGS. 6 and 8. The handle can be split by either molding the original handle with the four sections, cutting the four sections into the handle or by any other method known and used in the art.

As illustrated in FIG. 7, a bolt can then be inserted into a central portion of the handle to secure the head onto the handle. The bolt is preferably a carriage bolt, and more preferably an expansion carriage bolt, as illustrated in FIG. 8.

The handle can be made in several styles. Preferably the handle includes a fixed shaft with a ball mounted onto one end. This allows the handle to be shorter and more easily gripped and controlled. It also allows easy movement and use with less effort and bulk than required by standard tools. Additionally, since the tool is between the handle and the surface being tooled, the user's fingers are protected from any dirt, debris or the like.

Another preferable handle style includes a bent handle, as illustrated in FIG. 12. The bent handle allows a user to use the tool in a manner approximately parallel to the ground and thus also allows a user to use the tool to create a trench or the like. The bent handle is advantageous in that it is easy to grip and resists slipping in a user's hand. Additionally, the handle can also be made to rotate as needed, as illustrated in FIG. 12. The handle can be made in a variety of sizes and shapes, as illustrated in FIGS. 12-16.

Another preferable handle style includes a double rod handle, as illustrated in FIGS. 17, 21, 23 and 24. This handle will also decrease slipping and may be preferable to some users. With the double rod handle, branches or other narrow items can be broken by inserting the item between the double rods and twisting.

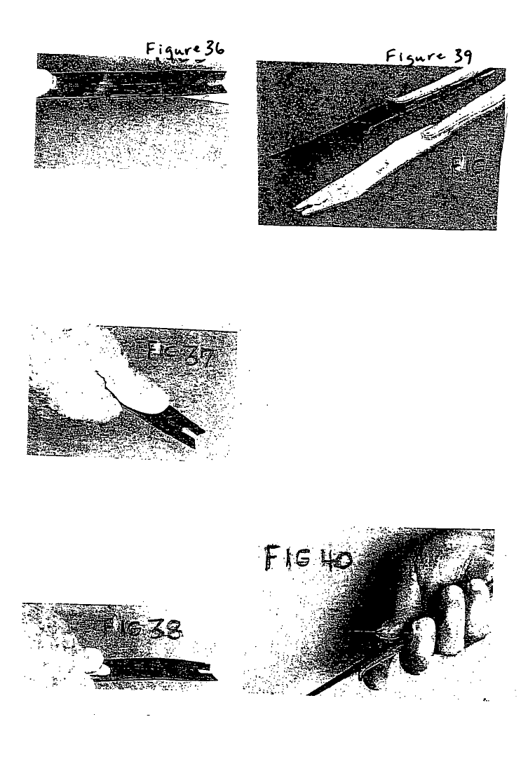

Another preferable handle style includes a dagger type handle, as illustrated in FIGS. 29-35. The handle allows the tool, which can include either the first or the second embodiment of the preferred invention, to be used as a trowel or flat blade digger. This handle can be held closer to the center portion of the tool, as illustrated in FIG. 34, or farther, as illustrated in FIG. 35.

The handle can also include a slide block, which can be used to lock a position for the blade, as illustrated in FIGS. 27 and 28. When the slide block is moved along the handle, the tool head can be released that the handle can be allowed to rotate until locked again into position.

Further, each preferred embodiment would preferably include a single 60 degree bevel on a bottom edge of the blade of the saw, rather than a double bevel, as the single bevel appears to be more effective for this application. While not wishing to be bound by theory, it is thought that the single bevel cuts through surfaces more easily than a double bevel because the single bevel can make a sharper entry into an item being cut than a double bevel.

A third preferred embodiment of the present invention includes producing a tool including the first and second preferred embodiments on a single head of a tool. In order to produce the tool, pressing, bending, or other methods known and used in the art may be employed. Preferably, the ridges mentioned above with respect to the first embodiment, can be included by pressing individual bends preferably using either a blank or a robotic arm, although other methods known and used in the art may be employed. Most preferably, a press bed may be used to provide the bends in the ridges of the first preferred embodiment. Using the press bed preferably includes providing the press bed and pressing individual blank heads into a desired shape.

In a fourth preferred embodiment of the present invention, a press bed is provided for manufacturing a tool including the first and second embodiment designs using the manufacturing process of the third embodiment. Preferably, the press bed would include ridges and spaces corresponding to the above mentioned first and second embodiments of the preferred embodiment.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A corrugated polymer headed tool, comprising:
a corrugated polymer head including a serrated blade surface with spaces between protrusions on one edge of the serrated blade surface, wherein the spaces are adaptively sized for a predetermined, specific use.

2. The tool of claim 1, wherein the spaces are circular, semicircular, v-shaped, rectangular, triangular, star-shaped, rectangular slotted, single sided grooved, multiple grooved, semicircular slotted, key hole shaped or irregular shaped along the at least one side surface.

3. The tool of claim 1, wherein the spaces are circular, wherein the circular space is adaptively sized for allowing dirt to pass through the circular space while catching debris for removal.

4. The tool of claim 1, wherein the spaces are circular, wherein the circular space is adaptively sized to catch debris above a predetermined size while passing debris below the predetermined size through the space.

5. The tool of claim 1, further comprising a flange located on an outer edge of the head, wherein the flange reinforces side portions of the tool.

6. The tool of claim 1, further comprising a handle.

7. The tool of claim 6, wherein the handle includes a fixed shaft with a ball mounted onto one end.

8. The tool of claim 6, wherein the handle includes a bent shaft.

9. The tool of claim 6, wherein the handle includes a double rod handle.

10. The tool of claim 9, further comprising a slide block.

11. The tool of claim 6, wherein the handle includes a dagger type handle.

12. The tool of claim 1, wherein the head further comprises a single 60 degree bevel on a bottom edge of the head.

13. A tool, comprising:
a head which includes a planar bottom portion, two triangular shaped side portions and a front portion, wherein the front portion includes a shaped planar sheet, wherein the planar sheet is shaped into a “U” shape which includes a space in a central portion thereof, and wherein the two triangular shaped side portions protrude in the front portion to create a pair of protrusions on upper portions of the front portion.

14. The tool of claim 13, wherein the space is adaptively sized for removing dandelions, and wherein the space is smaller than leaf bonnet portions of dandelions and larger than diameters of root portions of the dandelions.

15. The tool of claim 13, wherein the “U” shape is rectangular or conical.

16. The tool of claim 13, wherein the head comprises a polymer.

17. The tool of claim 13, wherein the head comprises a metal or metal alloy.

18. The tool of claim 13, further comprising a handle.

19. The tool of claim 18, wherein the handle includes a fixed shaft with a ball mounted onto one end.

20. The tool of claim 18, wherein the handle includes a bent shaft.

21. The tool of claim 18, wherein the handle includes a double rod handle.

22. The tool of claim 21, further comprising a slide block.

23. The tool of claim 18, wherein the handle includes a dagger type handle.

24. The tool of claim 13, wherein the head further comprises a serrated blade surface with spaces between protrusions on one edge of the serrated blade surface.

25. The tool of claim 24, wherein the spaces are circular, semicircular, v-shaped, rectangular, triangular, star-shaped, rectangular slotted, single sided grooved, multiple grooved, semicircular slotted, key hole shaped or irregular shaped along the at least one side surface.

26. The tool of claim 25, wherein the spaces are circular, wherein the circular space is adaptively sized for removing dandelions, and wherein the circular space is smaller than leaf bonnet portions of dandelions and larger than diameters of tap root portions of the dandelions.

27. The tool of claim 24, wherein the head and the serrated blade surface are concave.

28. The tool of claim 24, wherein the head and the serrated blade surface include ridges that increase the strength and stiffness of the tool.

29. The tool of claim 24, further comprising a flange located on an outer edge of the head, wherein the flange reinforces side portions of the tool.

30. The tool of claim 13, wherein the head further comprises a single 60 degree bevel on a bottom edge of the head.

31. The tool of claim 24, wherein the head further comprises a single 60 degree bevel on a bottom edge of the head.

32. A digger and utility garden tool, comprising:
a head comprising:
a first side which includes a planar bottom portion, two triangular shaped side portions and a front portion, wherein the front portion includes a shaped planar sheet, wherein the planar sheet is shaped into a “U” shape which is rectangular or conical and includes a space in a central portion thereof, and wherein the two triangular shaped side portions protrude in the front portion to create a pair of protrusions on upper portions of the front portion; and
a second side which includes a serrated blade surface with spaces between protrusions on one edge of the serrated blade surface on the other side, wherein the spaces in the serrated blade surface are circular, semicircular, v-shaped, or rectangular, wherein the head and the serrated blade surface are concave, wherein the head and the serrated blade surface include ridges that increase the strength and stiffness of the tool, wherein the head comprises a metal or a metal alloy, and further includes a flange that reinforces side portions of the tool, and wherein the head further comprises a single 60 degree bevel on a bottom edge of the head; and
a handle, wherein the handle comprises a fixed shaft with a ball mounted onto one end, a bent shaft, a double rod handle or a dagger type handle.

33. A tool, comprising:
a head including a serrated blade surface with spaces between protrusions on one edge of the serrated blade surface.

34. The tool of claim 33, wherein the spaces are circular, semicircular, v-shaped, rectangular, triangular, star-shaped, rectangular slotted, single sided grooved, multiple grooved, semicircular slotted, key hole shaped or irregular shaped along the at least one side surface.

35. The tool of claim 34, wherein the spaces are circular, wherein the circular space is adaptively sized for removing dandelions, and wherein the circular space is smaller than leaf bonnet portions of dandelions and larger than diameters of tap root portions of the dandelions.

36. The tool of claim 33, wherein the head and the serrated blade surface are concave.

37. The tool of claim 33, wherein the head and the serrated blade surface include ridges that increase the strength and stiffness of the tool.

38. The tool of claim 33, further comprising a flange located on an outer edge of the head, wherein the flange reinforces side portions of the tool.

39. The tool of claim 33, further comprising a handle.

40. The tool of claim 39, wherein the handle includes a fixed shaft with a ball mounted onto one end.

41. The tool of claim 39, wherein the handle includes a bent shaft.

42. The tool of claim 39, wherein the handle includes a double rod handle.

43. The tool of claim 42, further comprising a slide block.

44. The tool of claim 39, wherein the handle includes a dagger type handle.

45. The tool of claim 33, wherein the head comprises a polymer.

46. The tool of claim 33, wherein the head comprises a metal or a metal alloy.

47. The tool of claim 33, wherein the head further comprises a single 60 degree bevel on a bottom edge of the head.

48. A corrugated tool, comprising:
a head including a planar sheet which includes at least one side surface with a pair of protrusions and a space between the pair of protrusions, wherein the pair of protrusions extend from the at least one side surface and from a “U” shaped cross-section.

49. The corrugated tool of claim 48, wherein the head is a thermoset polymer.

50. The corrugated tool of claim 48, wherein the head is a thermoplastic polymer.

51. The corrugated tool of claim 48, wherein the head is a metal or metal alloy.

52. The tool of claim 48, wherein the space is adaptively sized for removing dandelions, and wherein the space is smaller than leaf bonnet portions of dandelions and larger than diameters of tap root portions of dandelions.
